(19) United States
(12) Patent Application Publication
(10) Pub. No.: US 2015/0370142 A1
(43) Pub. Date: Dec. 24, 2015

(54) DISPLAY APPARATUS AND DISPLAY APPARATUS MANUFACTURING METHOD

(71) Applicant: SEIKO EPSON CORPORATION, Tokyo (JP)

(72) Inventor: Takashi MIYATA, Shiojiri (JP)

(21) Appl. No.: 14/736,402

(22) Filed: Jun. 11, 2015

(30) Foreign Application Priority Data
Jun. 24, 2014 (JP) 2014-129596

(51) Int. Cl. G02F 1/167

(52) U.S. Cl. CPC G02F 1/167; G02F 2001/1676

(57) ABSTRACT

A display apparatus and a display apparatus manufacturing method are provided with which a favorable adhesiveness can be obtained by preventing an air bubble from entering. A display apparatus in the invention is a display apparatus in which a circuit board including a pixel circuit on which a pixel electrode is formed is adhered, via an adhesion layer, to a display sheet including a common electrode capable of applying a voltage between the common electrode and the pixel electrode. A surface of the circuit board to which the display sheet is adhered through the adhesion layer has a recess-and-projection structure including recess portions and projecting portions. In the recess-and-projection structure, the upper surface of each projecting portion is a flat surface.

### BACKGROUND

1. Technical Field

This application claims a priority to Japanese Patent Application No. 2014-129596 filed on Jun. 24, 2014 which is hereby expressly incorporated by reference in its entirety.

Several aspects of the present invention relate to a display apparatus and a display apparatus manufacturing method.

2. Related Art

Heretofore, an electrophoretic display apparatus, in which a circuit board having a pixel electrode formed on a circuit constituted by a switching element or the like is adhered to an electrophoretic layer via an adhesion layer, is known as a display apparatus (e.g., see JPA-2009-230061). When manufacturing this kind of electrophoretic display apparatus, in general, an electrophoretic sheet (display sheet) having a sheet shape is formed by being adhered to the circuit board using an adhesive.

However, in the above-described electrophoretic display apparatus, a problem arises in that, when the electrophoretic sheet is adhered via the adhesion layer, an air bubble enters between the circuit board and the adhesion layer since the upper surface of the circuit board is a flat surface, resulting in a decrease in the adhesiveness of the electrophoretic sheet.

### SUMMARY

One aspect of the invention has been made in order to solve the aforementioned problem, and an object thereof is to provide a display apparatus and a display apparatus manufacturing method with which a favorable adhesiveness can be obtained by preventing an air bubble from entering.

According to a first aspect of the invention, a display apparatus is provided in which a circuit board including a pixel circuit on which a pixel electrode is formed is adhered, via an adhesion layer, to a display sheet including a common electrode capable of applying a voltage between the common electrode and the pixel electrode. A surface of the circuit board to which the display sheet is adhered through the adhesion layer has a recess-and-projection structure including recess portions and projecting portions. An upper surface of each projecting portion of the recess-and-projection structure is a flat surface.

With the display apparatus according to the first aspect, an air bubble generated when adhering the display sheet to the circuit board is discharged to the outside along the recess portions of the recess-and-projection structure. Accordingly, since an air bubble is prevented from entering the inside of the adhesion layer, a decrease in the adhesiveness due to entering of an air bubble is prevented.

Furthermore, since the upper surface of each projecting portion is a flat surface, the adhesiveness between the adhesion layer and the recess-and-projection structure further improves, and the display sheet is favorably adhered to the circuit board via the adhesion layer.

In the first aspect, a configuration may be employed in which the plain area of the flat surface is 20 μm² or larger.

With this configuration, a sufficient area of the flat surface is secured, and accordingly the adhesiveness between the adhesion layer and the recess-and-projection structure can be improved.

In the first aspect, a configuration may be employed in which the height of the projecting portions with respect to the recess portions of the recess-and-projection structure is 1.0 μm or larger.

With this configuration, a sufficient depth of the recess portions is secured, and accordingly an air bubble can be reliably discharged to the outside along the recess portions.

In the first aspect, a configuration may be employed in which the display sheet is an electrophoretic sheet.

With this configuration, an electrophoretic display apparatus is provided in which the electrophoretic sheet is favorably adhered to the circuit board as a result of preventing an air bubble from entering.

According to a second aspect of the invention, a display apparatus manufacturing method in which a circuit board including a pixel circuit on which a pixel electrode is formed is adhered, via an adhesion layer, to a display sheet including a common electrode capable of applying a voltage between the common electrode and the pixel electrode is provided. In a process of forming the circuit board in this display apparatus manufacturing method, a recess-and-projection structure including projecting portions each having a flat surface as an upper surface thereof and recess portions is formed on a surface of the circuit board to which the display sheet is adhered through the adhesion layer.

With the display apparatus manufacturing method according to the second aspect, an air bubble generated when adhering the display sheet to the circuit board can be discharged to the outside along the recess portion of the recess-and-projection structure. Accordingly, an air bubble is prevented from entering the inside of the adhesion layer, and accordingly a decrease in the adhesiveness due to entering of an air bubble can be prevented.

Furthermore, since the upper surface of each projecting portion is a flat surface, the adhesiveness between the adhesion layer and the recess-and-projection structure further improves, and the display sheet can be favorably adhered to the circuit board via the adhesion layer.

In the second aspect, a configuration may be employed in which the recess-and-projection structure is formed such that the plain area of the flat surface is 20 μm² or larger.

With this configuration, the area of the flat surface is sufficiently secured, and accordingly the adhesiveness between the adhesion layer and the recess-and-projection structure can be improved.

In the second aspect, a configuration may be employed in which the recess-and-projection structure is formed such that the height of the projecting portions with respect to the recess portions is 1.0 μm or larger.

With this configuration, a sufficient depth of the recess portions is secured, and accordingly an air bubble can be reliably discharged to the outside along the recess portion.

In the second aspect, a configuration may be employed in which an electrophoretic sheet is used as the display sheet.

With this configuration, an electrophoretic display apparatus can be manufactured in which the electrophoretic sheet is favorably adhered to the circuit board as a result of preventing an air bubble from entering.

### BRIEF DESCRIPTION OF THE DRAWINGS

The invention will be described with reference to the accompanying drawings, wherein like numbers reference like elements.

FIG. 1 is an equivalent circuit diagram showing an electrophoretic display apparatus.

FIG. 2 is a cross-sectional view of the electrophoretic display apparatus.

FIG. 3 is a cross-sectional view of a microcapsule that constitutes an electrophoretic element.

FIGS. 4A and 4B are diagrams for illustrating operations of the electrophoretic element.

FIGS. 5A and 5B are cross-sectional views showing a main configuration of an element board.

FIGS. 6A, 6B, and 6C are diagrams showing exemplary plane structures of a recess-and-projection structure.

FIGS. 7A to 7C are diagrams showing exemplary processes of manufacturing the electrophoretic display apparatus.

### DESCRIPTION OF EXEMPLARY EMBODIMENTS

Hereinafter, an embodiment of the invention will be described in detail with reference to the drawings.

Note that, in the drawings used in the following description, a characteristic part is shown in an enlarged manner in some cases for convenience in order to facilitate understanding of the characteristics, and the dimensional ratio or the like of constituent elements are not necessarily the same as in reality.

This embodiment will describe an active-matrix electrophoretic display apparatus as an exemplary display apparatus.

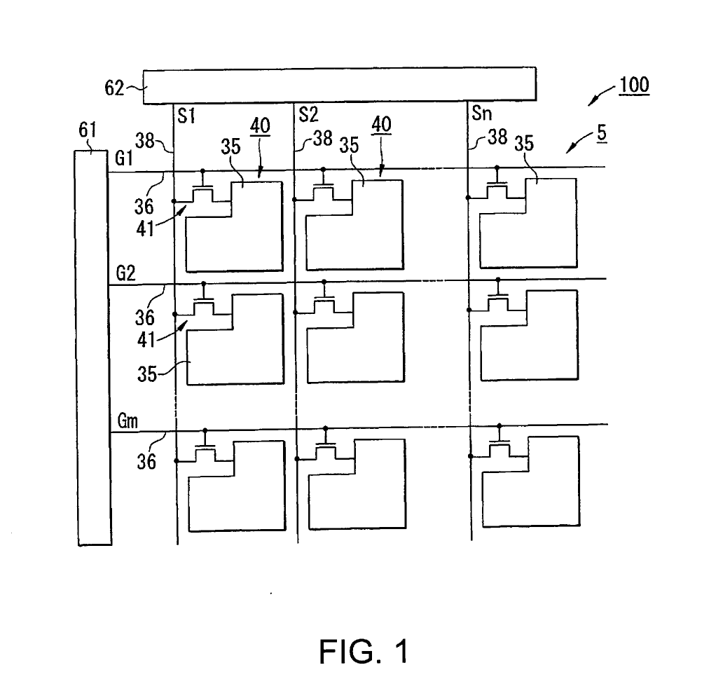

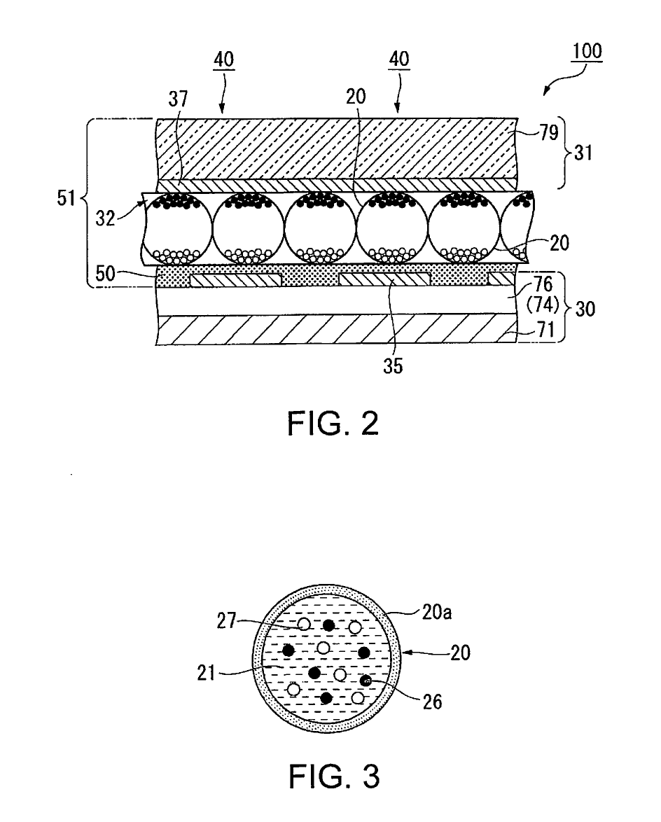

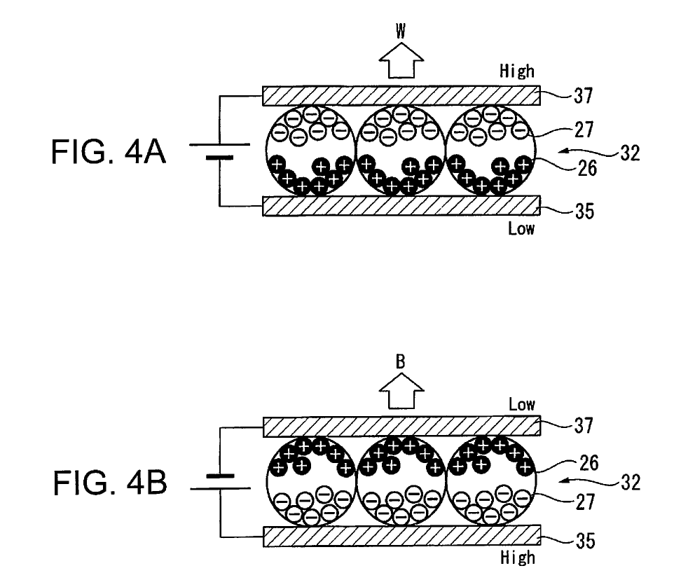

FIG. 1 is an equivalent circuit diagram showing an electrophoretic display apparatus in this embodiment. FIG. 2 is a cross-sectional view of the electrophoretic display apparatus in this embodiment. FIG. 3 is a cross-sectional view of a microcapsule that constitutes an electrophoretic element. FIGS. 4A and 4B are diagrams for illustrating operations of the electrophoretic element.

An electrophoretic display apparatus 100 in this embodiment includes a display portion 5 in which a plurality of pixels 40 are arrayed in matrix in a row direction and a column direction, as shown in FIG. 1. A scan line drive circuit 61 and a data line drive circuit 62 are arranged in the periphery of the display portion 5. The display portion 5 is provided with a plurality of scan lines 36 extending from the scan line drive circuit 61 and a plurality of data lines 38 extending from the data line drive circuit 62, and the pixels 40 are provided so as to correspond to intersecting positions of these lines. Each pixel 40 is provided with a selection transistor 41 and a pixel electrode 35.

Note that the “row direction” is the “horizontal direction” in the display portion, and corresponds to the left-right direction in FIG. 1. The “column direction” is the “vertical direction” orthogonal to the horizontal direction, and corresponds to the up-down direction in FIG. 1.

The scan line drive circuit 61 is connected to the pixels 40 via m scan lines 36 (G1, G2, . . . , Gm), sequentially selects the first to m^{th} scan lines 36, and supplies a selection signal that defines a timing of turning on the selection transistors 41 provided in the pixels 40, via the selected scan line 36. The data line drive circuit 62 is connected to the pixels 40 via n data lines 38 (S1, S2, . . . , Sn), and supplies, to each pixel 40, an image signal that defines pixel data corresponding to the pixel 40.

As shown in FIG. 2, the electrophoretic display apparatus 100 includes an element board 30 (circuit board), a common board 31, and an electrophoretic element 32 in which a plurality of microcapsules 20 sandwiched between the element board 30 and the common board 31 are arranged.

In this embodiment, the element board 30 is joined to the common board 31 by the electrophoretic element 32 being adhered to the pixel electrode 35 via the adhesion layer 50. In general, the electrophoretic element 32 is formed in advance on the side of the common board 31 and is handled as the electrophoretic sheet (display sheet) 51, which also includes the adhesion layer 50. In this embodiment, the electrophoretic sheet 51 is constituted by a sheet body including the adhesion layer 50, the electrophoretic element 32, a common electrode 37, and the board body 79.

In a later-described manufacturing process, the electrophoretic sheet 51 is handled in a state where a protection release sheet is adhered to a surface of the adhesion layer 50. The display portion 5 is formed by adhering the electrophoretic sheet 51 from which the release sheet has been removed, to the element board 30 on which the pixel electrode 35, the selection transistors 41, various circuits, and the like are separately formed. For this reason, the adhesion layer 50 exists only on the side of the pixel electrode 35.

The element board 30 includes the plurality of pixel electrodes 35 provided so as to correspond to the respective pixels 40. The pixel electrodes 35 are electrodes that are made of, for example, a transparent conductive material such as ITO (indium tin oxide), a metallic material such as Al, or the like, and apply a voltage to the electrophoretic element 32 between the pixel electrodes 35 and the later-described common electrode 37.

The common board 31 includes a board body 79 and the common electrode 37. The board body 79 is a board made of glass, plastic, or the like, and is a transparent board since it is arranged on a visually-recognized side. The common electrode 37 is formed on a surface of the board body 79 on the side of the electrophoretic element 32, so as to face the individual pixel electrodes 35. The common electrode 37 is an electrode that applies a voltage to the electrophoretic element 32 together with the pixel electrodes 35, and is made of a transparent conductive material such as MgAg (magnesium silver), ITO, or IZO (indium zinc oxide).

As shown in FIG. 3, each microcapsule 20 is a spherical body that has a particle diameter of about 50 μm, for example, and within which a dispersing medium 21, a large number of white particles (electrophoretic particles) 27, and a large number of black particles (electrophoretic particles) 26 are encapsulated. The microcapsules 20 are sandwiched between the common electrode 37 and the pixel electrodes 35 as shown in FIG. 2, and a plurality of microcapsules 20 are arranged within one pixel 40. Note that, although FIG. 2 shows a configuration in which a plurality of microcapsules 20 are arranged within one pixel 40, a configuration is also possible in which one microcapsule 20 is arranged within one pixel 40.

An outer shell portion 20a (wall film) of each microcapsule 20 is made of acrylic resin such as polymethyl methacrylate or polyethyl methacrylate, translucent high polymer resin such as urea resin or gum arabic, or the like. The dispersing medium 21 is a liquid that disperses the white particles 27 and the black particles 26 within each microcapsule 20.

Examples of the dispersing medium 21 include water, an alcoholic solvent (methanol, ethanol, isopropanol, butanol, octanol, methyl cellosolve, etc.), ester (acetic ester, acetic butyl, etc.), ketone (acetone, methyl ethyl ketone, methyl isobutyl ketone, etc.), aliphatic hydrocarbon (pentane, hexane, octane, etc.), alicyclic hydrocarbon (cyclohexane, methyl cyclohexane, etc.), aromatic hydrocarbon (benzene, toluene, benzene having long chain alkyl group (xylene, hexylbenzene, heptylbenzene, octylbenzene, nonylbenzene, decylbenzene, undecylbenzene, dodecylbenzene, tridecylbenzene, tetradecylbenzene, etc.)), halogenated hydrocarbon (methylene chloride, chloroform, carbon tetrachloride, 1,2-dichloroethane, etc.), carboxylate, and the like, and may also be other oils. These materials can be used independently or as a mixture, and a surfactant or the like may further be combined therewith.

The white particles 27 are particles (high polymers or colloid) made of white pigment such as titanium dioxide, zinc white, antimony trioxide, or the like, for example, and are used while being negatively charged, for example. The black particles 26 are particles (high polymers or colloid) made of black pigment such as aniline black or carbon black, for example, and is used while being positively charged, for example.

To these white pigment and black pigment, a charge control agent made of particles of an electrolyte, a surfactant, metallic soap, resin, gum, oil, varnish, a compound, or the like, a dispersant such as a titanium coupling agent, an aluminum coupling agent, or a silane coupling agent, a lubricant, a stabilizer, or the like can be added as necessary.

In place of the black particles 26 and the white particles 27, for example, pigment of red, green, blue, yellow, cyan, magenta, or the like may be used. With this configuration, red, green, blue, yellow, cyan, magenta, or the like can be displayed on the display portion 5 without using a color filter.

Note that, in place of the above configuration, a one-particle system may be used in which one type of charged particles is dispersed in a colored dispersing medium 21. Alternatively, a configuration may also be employed in which two or more types of charged particles are dispersed in a colored dispersing medium 21.

In place of the configuration in which the dispersing medium and the particles are encapsulated in the microcapsules, a configuration may also be employed in which the dispersing medium and the particles are loaded between the pair of boards. In this case, a partition may be provided between the pair of boards, and the dispersing medium and the particles may be loaded within cells demarcated by the partition.

When the pixels 40 are displayed in white in the electrophoretic element 32 having the above configuration, as shown in FIG. 4A, the common electrode 37 is held at a relatively high potential, and the pixel electrodes 35 are held at a relatively low potential. That is to say, with the potential of the common electrode 37 as a reference potential, the pixel electrodes 35 are held at a negative polarity. The negatively charged white particles 27 are thereby drawn to the common electrode 37, while the positively charged black particles 26 are drawn to the pixel electrodes 35. As a result, when these pixels are seen from the side of the common electrode 37, white color is visually recognized.

On the other hand, when the pixels 40 are displayed in black, as shown in FIG. 4b, the common electrode 37 is held at a relatively low potential, and the pixel electrodes 35 are held at a relatively high potential. That is to say, with the potential of the common electrode 37 as a reference potential, the pixel electrodes 35 are held at a positive polarity. The positively charged black particles 26 are thereby drawn to the common electrode 37, while the negatively charged white particles 27 are drawn to the pixel electrodes 35. As a result, when these pixels are seen from the side of the common electrode 37, black color is visually recognized.

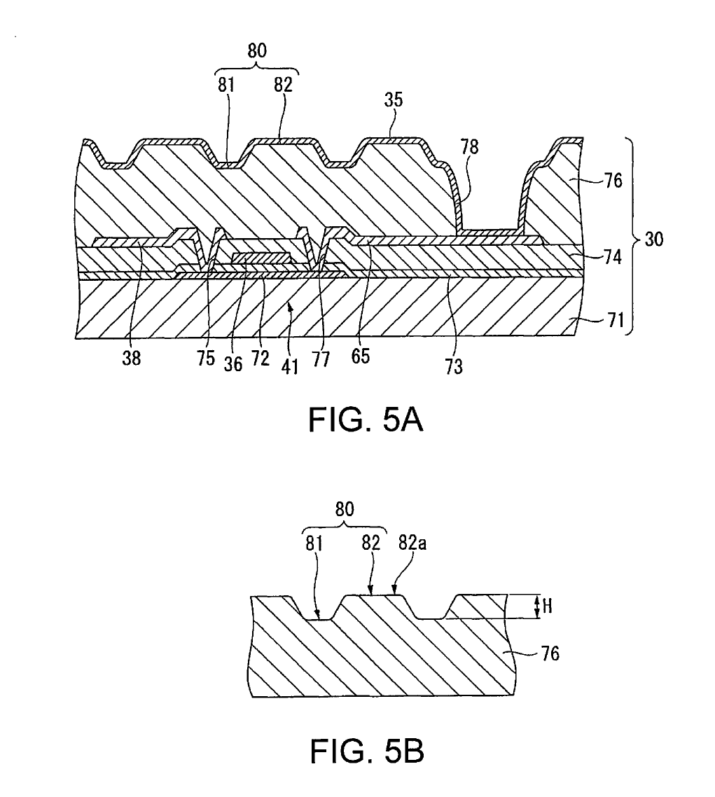

Subsequently, a configuration of the element board 30 will be described in detail. FIGS. 5A and 5B are cross-sectional views showing a main configuration of the element board 30. As shown in FIG. 5A, the scan lines 36, the data lines 38, the selection transistors 41, and the like shown in FIG. 1 are formed on a face on the side where the electrophoretic element 32 of the element board 30 is arranged.

A board body 71 that constitutes the element board 30 is made of glass, plastic, or the like. This board body 71 does not have to be transparent since it is arranged on the side opposite to the visually-recognized side. A semiconductor layer 72 is formed on a surface of the board body 71 on the side of the electrophoretic element 32, and a gate insulating film 73 is formed so as to cover the semiconductor layer 72. The semiconductor layer 72 may be, for example, a non-single-crystal silicon material such as amorphous silicon or poly-crystalline silicon, an oxide semiconductor material, a transparent oxide semiconductor material such as In—Ga—Zn—O, an organic semiconductor material such as a fluorine-bithiophene copolymer, or the like. When using an oxide semiconductor material as the semiconductor layer 72, it is desirable to also use an oxide insulating material as the gate insulating film 73. When using an organic semiconductor material as the semiconductor layer 72, it is desirable to also use an organic insulating material as the gate insulating film 73.

The scan lines 36 functioning as gate electrodes of the selection transistors 41 are formed on the gate insulating film 73. The scan lines 36 may be, for example, a metallic multi-layer film of an Al—Nd alloy and Mo or the like. In other cases, Al element, ITO, Cu, Cr, Ta, Mo, Nb, Ag, Pt, Pd, In, Nd, an alloy thereof, or the like may be used.

A first inter-layer insulating film 74 is formed over the entire board body 71 so as to cover the scan lines 36. The first inter-layer insulating film 74 may be, for example, an inorganic insulating material such as a silicon nitride film, a silicon oxide film, or a silicon nitride oxide film, or an organic insulating material. The data lines 38, each of which is electrically connected to a source region of the semiconductor layer 72 via a contact hole 75, are formed on the first inter-layer insulating film 74. Drain lines (drain electrodes) 65, each of which is electrically connected to a drain region of the semiconductor layer 72 via a contact hole 77, are formed on the first inter-layer insulating film 74. A material similar to that of the scan lines 36 can also be used for the data lines 38 and the drain lines 65. Note that, although FIG. 5A shows a top gate structure in which the gate electrode is formed on an upper side in FIG. 5A with respect to the semiconductor layer 72, a bottom gate structure in which the gate electrode is formed below the semiconductor layer 72 may be employed.

A second inter-layer insulating film 76 is formed over the entire first inter-layer insulating film 76 so as to cover the data lines 38 and the drain lines 65. The second inter-layer insulating film 76 may be made of, for example, an inorganic insulating material such as a silicon nitride film, a silicon oxide film, or a silicon nitride oxide film, or an organic insulating material, as with the first inter-layer insulating film 74. The pixel electrodes 35, each of which is electrically connected to the drain region of the semiconductor layer 72 via the drain line 65 and a contact hole 78, are formed on the second inter-layer insulating film 76. Although the plane shape of the pixel electrodes 35 is not shown here, the pixel electrodes 35 are each formed in a substantially rectangular shape in accordance with the arrangement in which the data lines 38 are substantially orthogonal to the scan lines 36.

Incidentally, in the electrophoretic display apparatus 100 in this embodiment, the element board 30 is joined to the common board 31 by the electrophoretic element 32 being adhered to the pixel electrodes 35 via the adhesion layer 50, as shown in FIG. 2. For this reason, in the electrophoretic display apparatus 100, improvement in the adhesiveness of the adhesion layer 50 and prevention of an air bubble from entering at the time of adhesion are desired. This is because the reliability of the apparatus will deteriorate, since the mechanical strength decreases if the adhesiveness of the adhesion layer 50 decreases. It is also because the quality of display will decrease if an air bubble enters the inside of the adhesion layer 50.

On the other hand, in the this embodiment, the upper surface of the second inter-layer insulating film 76, i.e., the surface thereof to which the electrophoretic sheet 51 is adhered has a recess-and-projection structure 80. The recess-and-projection structure 80 includes recess portions 81 and projecting portions 82. The pixel electrode 35 has a shape with recesses and projections, which conforms to the shape of the recess-and-projection structure 80.

Incidentally, in the element board 30, the semiconductor layer 72, the scan lines 36, and the data lines 38 are formed in a layer below the second inter-layer insulating film 76, as shown in FIG. 5A. These semiconductor layer 72, scan lines 36, and data lines 38 are formed in a predetermined region in the display portion 5, and therefore, they partially intersect on the board, as viewed in a plan view. For the above reason, the element board 30 has a projection structure in which portions where at least two of the aforementioned semiconductor layer 72, scan lines 36, and data lines 38 intersect in a plane project upward of the other portions.

In this embodiment, as described above, the recess-and-projection structure 80 is formed in the second inter-layer insulating film 76 serving as the surface to which the electrophoretic sheet 51 is adhered. The film thickness of the second inter-layer insulating film 76 is relatively thin in the recess portion 81 in the recess-and-projection structure 80. For this reason, if the aforementioned projection structure formed on the element board 30 overlaps the recess portions 81 in the recess-and-projection structure 80 in a plane, the film thickness of the second inter-layer insulating film 76 becomes thinner than a predetermined film thickness (minimum film thickness). If the film thickness of the second inter-layer insulating film 76 becomes thin, the insulation characteristic in the element board 30 degrades, and a malfunction such as a failure in display may possibly occur as a result of being unable to apply a predetermined voltage to the electrophoretic element 32. Furthermore, in a portion of the second inter-layer insulating film 76 with a thin film thickness, a peculiar projecting portion such as a foreign matter existing in the element board 30 cannot be buried, and there is a possibility that this foreign matter is exposed to the surface.

For this reason, in the electrophoretic display apparatus 100 according to this embodiment, the film thickness of the second inter-layer insulating film (coating layer) 76 is secured by adjusting a plane positional relationship between the recess-and-projection structure 80 and the projection structure formed on the element board 30. The predetermined voltage can thereby be applied to the electrophoretic element 32, and a malfunction such as a failure in display can be prevented. Furthermore, a peculiar projecting portion such as a foreign matter existing in the element board 30 can be reliably buried.

As shown in FIG. 5B, in the recess-and-projection structure 80, an upper surface 82a of each projecting portion 82 is a flat surface. Note that FIG. 5B omits the pixel electrodes 35. In this embodiment, the flat face of the upper surface 82a is formed so as to be smaller than each pixel electrode 35, as shown in FIG. 5A. Specifically, the flat surface of the upper surface 82a need only have a plain area (area as viewed in a plan view) of 20 μm² or larger. Furthermore, it is desirable in the recess-and-projection structure 80 that the height H of the projecting portions 82 with respect to the recess portions 81 is set to 1.0 μm or larger. In this embodiment, a favorable adhesiveness was obtained by preventing an air bubble from entering when the height H was set to about 1.5 μm. The recess portion 81 is formed so as to be in communication with the outside of the display portion 5.

In this embodiment, the size of the electrophoretic sheet 51 adhered to the element board 30 through the adhesion layer 50 is larger than the size of a region in which the recess-and-projection structure 80 is formed (i.e., the second inter-layer insulating film 76). For this reason, the adhesion layer 50 is in a state of covering a side end face of the second inter-layer insulating film 76. A sealing material seals the display portion 5 and a peripheral circuit portion so as to be in contact with the adhesion layer 50. With this configuration, an outer edge portion of the recess-and-projection structure 80 (the second inter-layer insulating film 76) is covered with the adhesion layer 50 and the sealing material, and accordingly high sealing properties can be obtained so as to prevent moisture from entering the inside of the second inter-layer insulating film 76.

It is desirable to set the area percentage of the recess portions 81 and the projecting portions 82 of the recess-and-projection structure 80 is 10 to 90%.

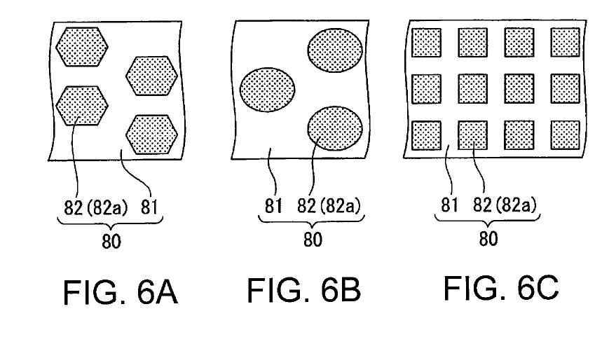

Subsequently, a plane structure of the recess-and-projection structure 80 will be described. FIGS. 6A, 6B, and 6C are diagrams showing exemplary plane structures of the recess-and-projection structure 80.

In the recess-and-projection structure 80, the flat surface shape of the upper surfaces 82a of the projecting portions 82 may be hexagonal as shown in FIG. 6A, circular as shown in FIG. 6B, or rectangular (square) as shown in FIG. 6C. Note that the flat surface shape of the upper surface of the projecting portions 82 is not limited thereto, and need only be a flat surface.

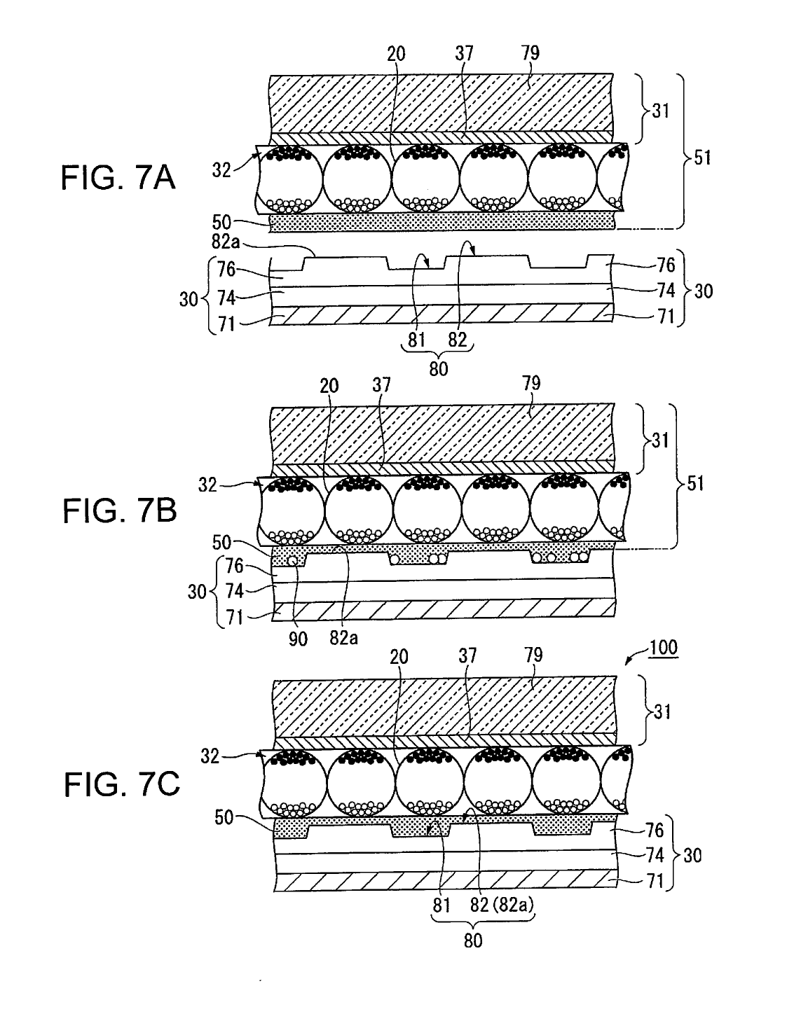

Subsequently, a method for manufacturing the electrophoretic display apparatus 100 will be described, and an effect of the above-described recess-and-projection structure 80 will also be described. FIGS. 7A to 7C are diagrams showing exemplary processes of manufacturing the electrophoretic display apparatus 100. Note that FIGS. 7A to 7C simplify the structure of the element board 30 and omit the pixel electrodes 35. FIGS. 7A to 7C also simplify the structure of the common board 31 and omit the common electrode 37.

Initially, the element board 30 including the pixel electrodes 35, the selection transistors 41, and various circuits is formed. The process of forming the element board 30 includes a step of forming the above-described recess-and-projection structure 80. For example, the recess-and-projection structure 80 is formed by adjusting the amount of exposure or the like when forming the second inter-layer insulating film 76 using a photolithography method.

Subsequently, the electrophoretic sheet 51 in a state where the protection release sheet is adhered to the surface of the adhesion layer 50 is prepared. Then, as shown in FIG. 7A, the electrophoretic sheet 51 from which the release sheet has been removed is adhered to the element board 30. The adhering of the electrophoretic sheet 51 and the element board 30 is performed by pressing them against each other in a state of being heated at a predetermined temperature.

Here, when adhering the electrophoretic sheet 51, air bubbles are generated between the adhesion layer 50 and the element board 30. When the electrophoretic sheet 51 is adhered to the element board 30 and the adhesion layer 50 comes into contact with the projecting portions 82 of the recess-and-projection structure 80, air bubbles 90 pressed out from the adhesion layer 50 and the projecting portion 82 flow into the recess portions 81, as shown in FIG. 7B.

The adhesion layer 50 enters the inside of the recess portions 81 by further pressing the electrophoretic sheet 51. In this embodiment, the recess portions 81 are formed so as to be in communication with the outside of the display portion 5, and accordingly the air bubbles 90 that have flown into the recess portions 81 are reliably discharged to an outer region. Ultimately, as shown in FIG. 7C, the electrophoretic element 32 is adhered to the element board 30 via the adhesion layer 50, and the electrophoretic display apparatus 100 is thereby manufactured in which the element board 30 is joined to the common board 31.

According to this embodiment, the air bubbles 90 generated when adhering the electrophoretic sheet 51 to the element board 30 can be favorably discharged to the outside by favorably pressing the air bubbles 90 into the recess portions 81 using the projecting portions 82 having the flat upper surfaces 82a. Accordingly, the air bubbles 90 are prevented from entering the inside of the adhesion layer 50, and therefore a decrease in the adhesiveness due to entering of the air bubbles 90 is prevented. Furthermore, since the upper surface 82a of each projecting portion 82 is a flat surface, a high adhesiveness can be achieved as a result of the adhesion layer 50 and the projecting portions 82 favorably coming into close contact. For this reason, the adhesiveness between the adhesion layer 50 and the recess-and-projection structure 80 further improves, and the electrophoretic sheet 51 is favorably adhered to the element board 30 via the adhesion layer 50.

In this embodiment, since the area of each upper surface 82a is 20 μm² or larger and is thus sufficiently secured, the adhesiveness between the adhesion layer 50 and the recess-and-projection structure 80 can be improved. Furthermore, the height H of the projecting portions 82 with respect to the recess portions 81, i.e., the depth of the recess portions 81 is 1.0 μm or larger (e.g., about 1.5 μm). Accordingly, a sufficient depth of the recess portions 81 is secured, and the air bubbles 90 can thereby be reliably discharged to the outside.

Note that the technical scope of the invention is not limited to the above-described embodiment, and can be modified in various manners within the scope without departing from the gist of the invention.

Although the above embodiment has described, as an example of a display apparatus, the electrophoretic display apparatus 100 in which the element board 30 is adhered to the electrophoretic sheet 51 via the adhesion layer 50, the invention is not limited thereto. That is to say, the invention is also applicable to, for example, a liquid crystal display apparatus or an organic electroluminescence apparatus in which a display sheet adhered via an adhesion layer includes a liquid crystal layer or an organic electroluminescence element.

What is claimed is:

1. A display apparatus comprising:
a circuit board including a pixel circuit on which an pixel electrode is formed;
a display sheet adhered to the circuit board; and
a common electrode installed on a surface of the display sheet, the surface being opposite to a surface thereof to which the circuit board is adhered,
wherein a surface of the circuit board to which the display sheet is adhered has a recess-and-projection structure having a plurality of projecting portions each having a flat upper surface, and
the upper surface of some of the plurality of projecting portions is the pixel electrode, and the plurality of projecting portions are adhered to the display sheet through an adhesion layer.

2. The display apparatus according to claim 1,
wherein the area of the upper surface of each of the projecting portions is 20 μm² or larger.

3. The display apparatus according to claim 1,
wherein the height of the projecting portions of the recess-and-projection structure is 1.0 μm or larger.

4. The display apparatus according to claim 1,
wherein the display sheet is an electrophoretic sheet.

5. The display apparatus according to claim 1,
wherein the common electrode is formed on a common board, and
the common board on the side of the common electrode is adhered to the display sheet.

6. A display apparatus manufacturing method comprising:
forming a pixel circuit in a circuit board;
forming an insulating film having a projecting portion on the pixel circuit;
forming a pixel electrode in a region including the projecting portion; and
adhering a display sheet to the projecting portion via an adhesion layer,
wherein an upper surface of the projecting portion is flat, and
the insulating film has a recess-and-projection structure having a plurality of the projecting portions.

7. The display apparatus manufacturing method according to claim 6,
wherein the area of the upper surface of each of the projecting portions is 20 μm² or larger.

8. The display apparatus manufacturing method according to claim 6,
wherein the height of the projecting portions of the recess-and-projection structure is 1.0 μm or larger.

9. The display apparatus manufacturing method according to claim 6,
wherein an electrophoretic sheet is used as the display sheet.

10. The display apparatus manufacturing method according to claim 6,
further comprising adhering a common board having a common electrode to the display sheet such that the common board on the side of the common electrode is oriented toward the side of the display sheet.
